(19) United States
(12) Patent Application Publication
(10) Pub. No.: US 2005/0269019 A1
(43) Pub. Date: Dec. 8, 2005

(54) Method of manufacturing a framework having a honeycomb structure

(76) Inventor: Alethea Rosalind Melanie Hall, Muldersdrift (ZA)

Correspondence Address: LADAS & PARRY LLP, 224 SOUTH MICHIGAN AVENUE, SUITE 1600, CHICAGO, IL, 60604, US

(21) Appl. No.: 10/523,862

(22) PCT Filed: Aug. 8, 2003
(86) PCT No.: PCT/IB03/03212

§ 371 Date: Mar. 9, 2005

(30) Foreign Application Priority Data
Aug. 8, 2002 (ZA) 2002/6345

(51) Int. Cl. B31D 3/02; B32B 3/28

(52) U.S. Cl. 156/197; 156/73.3; 156/292; 156/290; 428/116

(57) ABSTRACT

This invention relates to a method of manufacturing a framework having a honeycomb structure with a plurality of compartments running the length of the framework, the method comprising joining a first sheet of a flexible material to a second sheet along a plurality of join lines to form a first row of compartments, joining a third sheet to the second sheet along a plurality of intermediate join lines to form a second row of compartments, joining a fourth sheet to the third sheet, and so on. At least some of the compartments may be closed at a first end or a second end or at both ends of the framework. A further embodiment of the invention relates to a framework produced by the method. The invention may be used in the manufacture of various structures including mine supports, dam walls, storage packs, artificial reef units, road supports, contamination barriers, linings and the like.

### BACKGROUND OF THE INVENTION

This invention relates to a method of manufacturing a framework having a honeycomb structure with a plurality of compartments running the length of the framework from a first end to a second end, for use, for example, in the construction of a structure such as a mine support, a dam wall or an artificial reef unit or the like, where at least some of the compartments are closed at at least one end.

It is well known to form support structures such as roadways, canals or river or bank linings, mine supports and artificial reef units from a material having an open honeycomb structure, i.e having a plurality of compartments or cells divided by dividing walls, each compartment or cell being filled with a suitable filler material. Examples of such materials having an open honeycomb structure for use in these support structures are Hyson-Cells from M & S Technical Consultants & Services (Pty) Limited, Geoweb from Presto Products Company, Tenweb from Tenax Corp, Armater from Crow Company, Terracell from Webtech Inc, Envirogrid from Akzo Nobel Geosynthetics Co, and Geocells from Kaytech.

It is also known how to manufacture such materials having an open honeycomb structure. An example is illustrated in U.S. Pat. No. 4,478,659 to A R M Hall.

### SUMMARY OF THE INVENTION

According to a first aspect of the invention there is provided a method of manufacturing a framework having a honeycomb structure with a plurality of compartments running the length of the framework from a first end to a second end thereof, with at least some of the compartments being closed at the first end or at the second end or at both ends of the framework, from a plurality of sheets of a flexible material, including the steps of:
joining a first sheet to a second sheet along a plurality of join lines to form a first row of compartments,
joining a third sheet to the second sheet along a plurality of join lines intermediate the join lines between the first and second sheets to form a second row of compartments,
joining a fourth sheet to the third sheet along a plurality of join lines to form a third row of compartments,
and so on to form the honeycomb structure, and
closing at least some of the compartments at the first end of the framework or at the second end of the framework or at both ends of the framework.

When it is desired to close some or all of the compartments at the first end of the framework, the closure step preferably comprises:
providing a skirt depending from an edge of each sheet at the first end of the framework and either joining the skirt on the first sheet to the second sheet to close the first row of compartments, joining the skirt on the second sheet to the third sheet to close the second row of compartments and so on; or joining the skirt on the first sheet to the skirt on the second sheet to close the first row of compartments, joining the skirt on the third sheet to the skirt on the fourth sheet to close the third row of compartments, and so on.

Alternatively, when it is desired to close all of the compartments at the first end of the framework, the closure step preferably comprises:
providing a skirt depending from an edge of the first sheet and a skirt depending from an edge of the last sheet at the first end of the framework, providing two skirts depending from an edge of every sheet intermediate the first and the last sheets at the first end of the framework, joining the skirt on the first sheet to an adjacent skirt on the second sheet to close the first row of compartments, joining adjacent skirts on the second and third sheets together to close the second row of compartments, joining adjacent skirts on the third and fourth sheets together to close the third row of compartments, and so on.

If desired, certain of the skirts may be omitted so as to leave certain of the compartments open with others being closed.

The same procedure may be repeated at the second end of the framework to close some or all of the compartments at the second end of the framework as well.

The method of joining the sheets together along join lines, as well as the method of closing at least some of the compartments at the first end of the framework or at the second end of the framework or at both ends of the framework may be any suitable method such as for example heat or ultrasonic welding, sewing, gluing or the like.

The sheets may be made from a variety of materials, including (but not limited to) plastics materials, non-woven materials, composites with laminates (such as aluminium), or any flexible material where one sheet can be joined to another. The material may permit the framework to be hot- or cold-filled with toxic chemicals in liquid, gas or powder form, heavy metals, mine tailings, mine sludge or the like.

According to a second aspect of the invention there is provided a framework having a honeycomb structure with a plurality of compartments running the length of the framework from a first end to a second end with at least some of the compartments being closed at the first end or at the second end or both of the framework, the framework being manufactured from a plurality of sheets of a flexible material.

The framework of the invention may be used in the manufacture of various structures including mine supports, dam walls, storage packs, artificial reef units, roof supports, vertical and horizontal pressure supports, contamination barriers and the like.

### BRIEF DESCRIPTION OF THE DRAWINGS

FIG. 1 is a perspective view of a plurality of sheets of a flexible material prior to being joined to one another to form a framework of the invention;

FIG. 2 is a perspective view of a framework formed from the sheets of FIG. 1, prior to closure of some or all of the compartments at a first end or a second end of the framework;

FIGS. 2a are plan views of alternative embodiments of compartments formed and 2b by the framework of FIG. 1;

FIG. 3 is a view along the arrow A of the framework of FIG. 2;

FIG. 4 is a view along the arrow B of the framework of FIG. 2;

FIG. 5 is a schematic view of a first method of closure of some or all of the compartments of the framework of FIG. 2;

FIG. 6 is a schematic view of a second method of closure of some or all of the compartments of the framework of FIG. 2;

FIG. 7 is a schematic view of a third method of closure of some of the compartments of the framework of FIG. 2;

FIG. 8 is a schematic view of the closure of some or all of the compartments at both ends of the framework of FIG. 2;

FIG. 9 is a view along the arrow B of the framework of FIG. 2;

FIG. 10 is a schematic view of the closure of some or all of the compartments of the framework of FIG. 2; and

FIG. 11 is a schematic view of an alternative embodiment of the framework of the invention.

### DESCRIPTION OF EMBODIMENTS

The crux of the invention is that a framework having a honeycomb structure with a plurality of compartments running the length of the framework from a first end to a second end, which is manufactured from a plurality of sheets of a flexible material, has some or all of the compartments closed at the first end or at the second end or at both ends of the framework.

The closure of some or all of the compartments allows material filled into the compartments to be contained therein, for various purposes.

The method of manufacture of the framework of the invention will now be described with reference to the accompanying drawings.

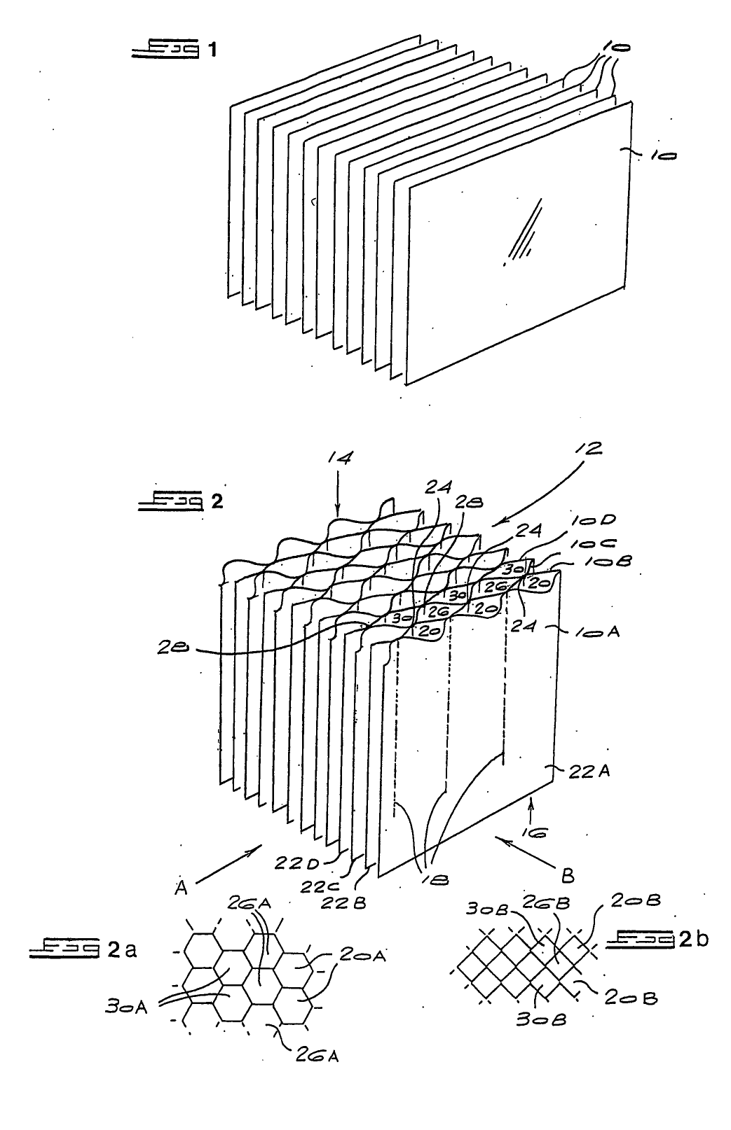

Referring to FIG. 1, there is provided a plurality of sheets 10 of a plastics or other suitable flexible material.

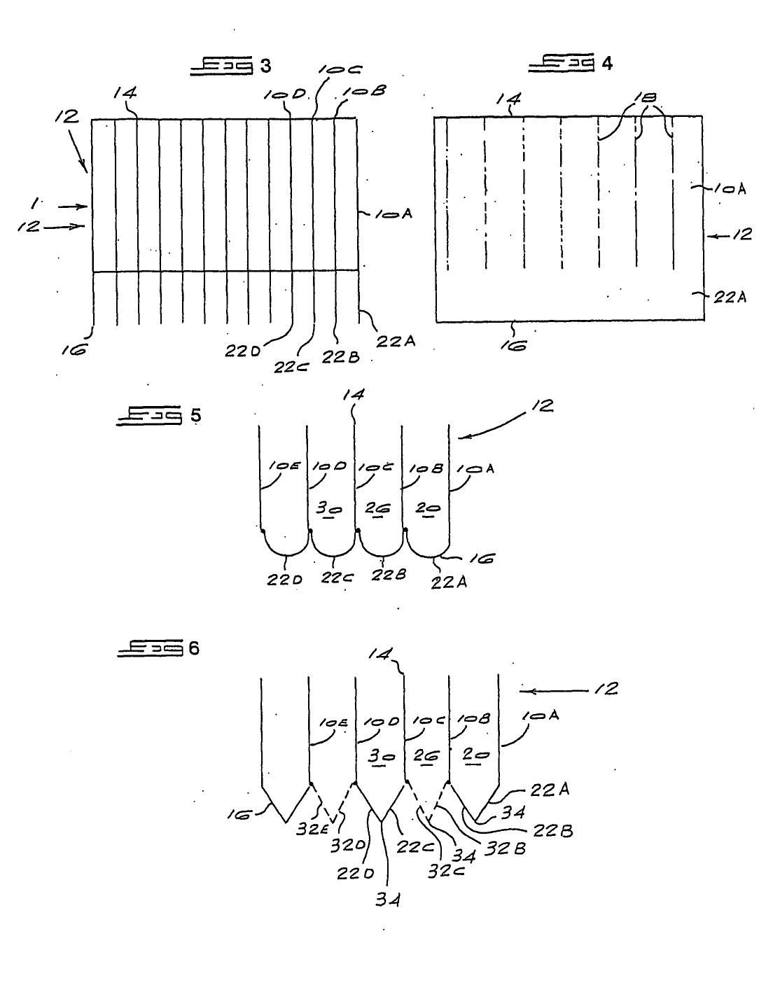

Referring to FIGS. 2 to 4, a framework 12 having a first end 14 and a second end 16 is formed from the plurality of sheets 10 as follows.

A first sheet 10A is joined to a second sheet 10B along a plurality of join lines 18 to form a first row of compartments 20. It can be seen that the join lines 18 stop short of one of the ends of the sheets 10A, 10B so as to leave a skirt 22A depending from the sheet 10A and similarly a skirt 22B depending from the sheet 10B.

Thereafter, a third sheet 10C is joined to the second sheet 10B along a plurality of join lines 24 which again are generally substantially parallel, and which are intermediate the join lines 18, to form a second row of compartments 26. Again the join lines 24 stop short of one of the ends of the sheet 10B, 10C so as to leave a skirt 22C depending from the third sheet 10C.

Thereafter, a fourth sheet 10D is joined to the third sheet 10C along a plurality of join lines 28 which again are generally substantially parallel, and which in this particular embodiment are in register with the join lines 18 (although the join lines 28 need not necessarily be in register with the join lines 18), to form a third row of compartments 30. Again the join lines 28 stop short of one of the ends of the sheets 10C, 10D so as to leave a skirt 22D depending from the fourth sheet 10D.

This process is continued to form the framework 12.

The join lines 18, 24, 28, etc., may be formed in any suitable manner, for example by heat or ultrasonic welding, by sewing or by gluing. Depending on the thickness of the join lines 18, 24, 28, etc, the shape of the compartments may be either hexagonal compartments 20A, 26A, 30A, etc. or quadrangular compartments 20B, 26B, 30B, etc., as illustrated in FIGS. 2a and 2b, respectively.

The next step is to close some or all of the rows of compartments 20, 26, 30, etc., at the second end 16 of the framework 12.

A first method of closing some or all of the compartments is illustrated in FIG. 5. The skirt 22A depending from the sheet 10A is folded over and joined to the sheet 10B at the end of the join lines 18 between the sheets 10A and 10B so as to close the row of compartments 20 at the second end 16 of the framework 12. Likewise the skirt 22B depending from the sheet 10B is folded over and joined to the sheet 10C at the end of the join lines 24 between the sheets 10B and 10C so as to close the row of the compartments 26. In a similar manner the skirt 22C is joined to the sheet 10D and the skirt 22D is joined to the sheet 10E to close the row of compartments in the various rows in the framework 12. In this way, all of the rows of compartments 20, 26, 30, etc., in the framework 12 are closed at the second end 16 of the framework 12.

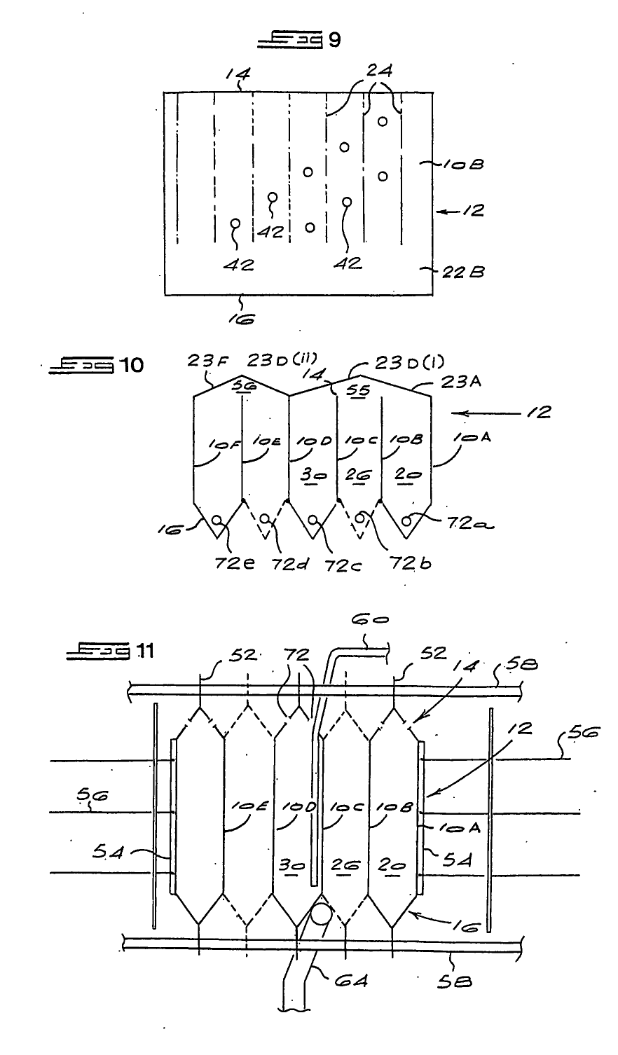

It is to be noted that the compartments in a row are in communication with each other, e.g. all the compartments 20 are in communication with each other, but not in communication with the compartments 26, 30 etc in other rows. In an alternative embodiment shown in FIG. 9, one or more of the internal sheets 10B, 10C, etc has openings 42 which permit communication between adjacent compartments in different rows, e.g. between compartments 20 and 26.

If desired, the join lines 18, 24, 28 may then be extended so as to close each compartment 20, 26, 30 from adjacent compartments 20, 26, 30 in the same row.

Thus, any material filled into the compartments 20, 26, 30, etc., is contained in the compartments 20, 26, 30, etc., by virtue of the closure of these compartments 20, 26, 30, etc., of the framework 12.

The joining of the skirts 22A, 22B, etc., to the adjacent sheets 10B, 10C, etc., may be achieved in the same manner as the formation of the join lines 18, 24, 28, for example by heat or ultrasonic welding, by sewing or by gluing.

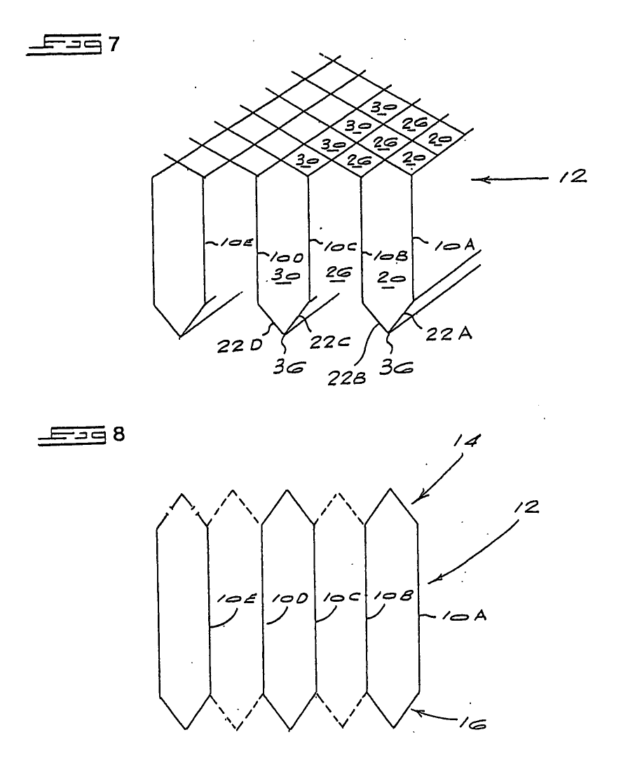

Referring to FIG. 6, a second method of closure of some or all of the compartments 20, 26, 30 in the framework 12, is illustrated. Firstly, additional skirts 32 are joined to the sheets 10B, 10C and in fact all sheets intermediate the first sheet 10A and the last sheet of the framework 12 so that each intermediate sheet 10B, 10C, etc., has two skirts 22, 32 depending therefrom.

Thereafter, the skirt 22A on the sheet 10A is joined to the skirt 22B on the sheet 10B at 34 to close the row of compartments 20. The skirt 32B attached to the sheet 10B is joined to the skirt 32C attached to the sheet 10C at 34 to close the row of compartments 26. Thereafter the skirt 22C on the sheet 10C is joined to the skirt 22D on the sheet 10D at 34 to close the row of compartments 30. This process is continued until some or all of the rows of compartments 20, 26, 30, etc., in the framework 12 are closed at the second end 16 of the framework 12. Again, in a similar way to that described above, each compartment in a row may be closed off from adjacent compartments in the same row. Again, the skirts 22, 32 may be joined to one another by means of heat or ultrasonic welding, by sewing or by gluing.

Referring to FIG. 7, a third method of closure of some or all of the compartments 20, 26, 30 in the framework 12, is illustrated. The skirt 22A on the sheet 10A is joined to the skirt 22B on the sheet 10B at 36 to close the row of compartments 20. The skirt 22C on the sheet 10C and the skirt 22D on the sheet 10D are joined at 36 to close the row of compartments 30. The second row of compartments 26 and every second row thereafter are left open.

As indicated above, it is possible to close some or all of the rows of compartments at both ends 14, 16 of the framework 12. This is specifically illustrated in FIG. 8 where all of the rows of compartments are closed, in the same manner as illustrated in FIG. 6.

The method of closing some or all of the compartments at one end 14 may be different to the method of closing some or all of the compartments at the other end 16, as illustrated in FIG. 10. The compartments 20, 26, 30 are closed at one end 16 according to the method illustrated in FIG. 6, but a unit 55 comprising a number of rows of compartments in communication with each other is formed by joining a skirt 23A at the end 14 of sheet 10A to a skirt 23D(i) at the end 14 of sheet 10D. A similar unit 56 is formed by joining a skirt 23D(ii) to skirt 23F to sheet 10F.

When some or all of the rows of compartments at one end of the framework are closed, particularly the end of the framework intended to rest on a base in use, the compartments may be filled with a material which is then retained in the closed compartments. This may assist in the formation of structures such as dam walls or artificial reef units.

When all of the rows of compartments are closed at both ends of the framework so that the framework is in essence sealed, a material may be filled into or drained from the compartments through suitable openings 72 (FIGS. 10 and 11). Some of the openings may be non-return valves, although in some circumstances the openings may permit the material to also flow out of the compartments, and the openings may be closed when it is no longer desired that the material be permitted to flow out of the compartments. Such a situation would arise when a first material in the compartments is replaced with a second material.

In addition the framework may then be pressurized by introducing a fluid or fluidized solid under pressure into the framework, which may be useful where the framework is being used in the manufacture of a mine support. A hose or pipe 60 may be inserted through the openings to introduce the fluid or fluidized solid. The framework may include engaging means for a vibrator 64 or the like to facilitate compaction or pre-stressing of the material within the compartment, as illustrated in FIG. 11.

The closure of compartments may also assist where it is intended to stack frameworks one on top of another.

A first framework may be attached to a second similar framework to build a larger structure. For example a first end of a first framework 12 as illustrated in FIG. 8 may be attached to a second end of a second framework 12 as illustrated in FIG. 8, e.g. by heat or ultrasonic welding, by sewing or by gluing.

It is also possible to form a plurality of holes in the framework, or in an extension or extensions 52 and 54 to the framework, so that flexible stays 56 or rigid rods 58 or the like may be inserted through the holes to anchor the framework in position in use, as illustrated in FIG. 11.

1. A method of manufacturing a framework having a honeycomb structure with a plurality of compartments running the length of the framework from a first end to a second end thereof, with at least some of the compartments being closed at the first end or at the second end or at both ends of the framework, from a plurality of sheets of a flexible material, including the steps of:
joining a first sheet to a second sheet along a plurality of join lines to form a first row of compartments;
joining a third sheet to the second sheet along a plurality of join lines intermediate the join lines between the first and second sheets to form a second row of compartments;
joining a fourth sheet to the third sheet along a plurality of join lines to form a third row of compartments, and so on to form the honeycomb structure; and
closing at least some of the compartments at the first end of the framework or at the second end of the framework or at both ends of the framework.

2. A method according to claim 1, wherein the step of closing at least some of the compartments comprises closing some or all of the compartments at the first end of the framework.

3. A method according to claim 2, wherein the closing step comprises providing a skirt depending from an edge of each sheet at the first end of the framework, joining the skirt on the first sheet to the second sheet to close the first row of compartments, joining the skirt on the second sheet to the third sheet to close the second row of compartments and so on.

4. A method according to claim 2, wherein the closing step comprises providing a skirt depending from an edge of each sheet at the first end of the framework, joining the skirt on the first sheet to the skirt on the second sheet to close the first row of compartments, joining the skirt on the third sheet to the skirt on the fourth sheet to close the third row of compartments, and so on.

5. A method according to claim 1, wherein the step of closing at least some of the compartments comprises closing all of the compartments at the first end of the framework.

6. A method according to claim 5, wherein the closing step comprises providing a skirt depending from an edge of the first sheet and a skirt depending from an edge of the last sheet at the first end of the framework, providing two skirts depending from an edge of every sheet intermediate the first and the last sheets at the first end of the framework, joining the skirt on the first sheet to an adjacent skirt on the second sheet to close the first row of compartments, joining adjacent skirts on the second and third sheets together to close the second row of compartments, joining adjacent skirts on the third and fourth sheets together to close the third row of compartments, and so on.

7. A method according to claim 3, wherein certain of the skirts are omitted or are not joined to another skirt or sheet so as to leave certain of the compartments open with others being closed.

8. A method according to claim 2, wherein the closing step is repeated at the second end of the framework.

9. A method according to claim 1, wherein the method of joining the sheets together along join lines, as well as the method of closing at least some of the compartments at the first end of the framework or at the second end of the framework or at both ends of the framework may be any suitable method selected from the group consisting of heat or ultrasonic welding, sewing, and gluing.

10. A method according to claim 9, wherein the method of joining or closing is heat welding or ultrasonic welding.

11. A framework having a honeycomb structure with a plurality of compartments running the length of the framework from a first end to a second end with at least some of the compartments being closed at the first end or at the second end or both of the framework, the framework being manufactured from a plurality of sheets of a flexible material.

12. A framework according to claim 11, which is used in the manufacture of a structure selected from the group comprising mine supports, dam walls, storage packs, road supports, contamination barriers, artificial reef units, roof supports, vertical and horizontal pressure supports and contamination barriers.

13. A framework manufactured by the method of claim 1.

14. (canceled)

15. (canceled)
